(19) United States
(12) Patent Application Publication
(10) Pub. No.: US 2008/0017366 A1
(43) Pub. Date: Jan. 24, 2008

(54) Air-Conditioning System, Especially Automotive Air-Conditioning System

(75) Inventors: Evripidis Koukouravas, Neckartenzlingen (DE); Wolfgang Dieksander, Filderstadt (DE); Harald Horig, Bischweier (DE); Eugen Komarek, Heidelberg (DE); Otto Schulten, Illingen (DE); Gebhard Schweizer, Leonberg (DE)

Correspondence Address: FOLEY AND LARDNER LLP;SUITE 500, 3000 K STREET NW, WASHINGTON, DC, 20007, US

(73) Assignee: BEHR GmbH & Co. KG, Stuttgart (DE)

(21) Appl. No.: 11/630,343

(22) PCT Filed: Jun. 24, 2005
(86) PCT No.: PCT/EP05/06852

§ 371 Date: Dec. 21, 2006

(30) Foreign Application Priority Data
Jun. 24, 2004 (DE) 10 2004 030 693.1

(51) Int. Cl. B60H 1/34

(52) U.S. Cl. 165/204

(57) ABSTRACT

The invention relates to an air-conditioning system (1), especially an automotive air-conditioning system, which comprises an air conduction housing (1) and components disposed therein, such as at least one heater (H; h) and one insert (E; F) for supplying and/or mixing the air. Said insert (E; F) and/or the air conduction housing (1) comprises elements, especially flaps, which can be interlinked either directly or indirectly and can be regulated together, thereby converting a multi-zone air-conditioning system into an air-conditioning system with fewer zones.

The invention relates to an air-conditioning system, especially automotive air-conditioning system, in accordance with the precharacterizing clause of claim 1.

Conventional automotive air-conditioning systems have a different number of possible conditioning zones in the vehicle interior, depending on the level of comfort required. An essential differentiation can be made between single-, two-, three- or four-zone air-conditioning systems, depending in each case on how many zones of this type can be conditioned differently. The zones of the vehicle interior are divided into in each case front zones and rear zones, and driver and passenger zones, thus resulting essentially in four zones. The zoned structure of the air-conditioning system arises from the number of air-conditioning zones which can be supplied with differently conditioned air from the air-conditioning system. As a rule, the air-conditioning system, in particular the air-guiding housing with the air-guiding ducts arranged therein and the partitions subdividing the latter into several regions, is newly configured for each change in the number of zones. Thus, for each variant, in particular also with respect to the variants comprising a single-zone air-conditioning system, two-zone air-conditioning system and four-zone air-conditioning system, the entire air-conditioning system has to be newly constructed and special tools are required for each variant.

EP 1 288 031 A1 discloses a modularly constructed automotive air-conditioning system with means for distributing a main air flow and with a heating element for heating a second air flow. The air-conditioning system is arranged in a housing. The modular construction of the air-conditioning system is provided in at least three versions, namely for a single-, a two- and a three-zone air-conditioning system, which is suitable for producing an air flow at a predetermined temperature in the corresponding zones. In this case, the outer construction of the different versions of the air-conditioning system is identical, irrespective of the number of zones. The modular construction is formed essentially by a multiplicity of different inserts which subdivide the housing in accordance with the number of zones desired. In this case, inserts are fitted into the air-guiding housing, in accordance in each case with the number of zones desired. An air-conditioning system of this type still leaves something to be desired.

It is the object of the invention to provide an improved air-conditioning system.

This object is achieved by an air-conditioning system with the features of claim 1. Advantageous refinements are the subject matter of the subclaims.

According to the invention, an air-conditioning system is provided, especially an automotive air-conditioning system, with an air-guiding housing and components arranged in the same, such as a heater, if appropriate an additional heater and an insert for guiding and/or mixing the air, wherein the insert and/or the air-guiding housing have/has elements which can be connected to one another directly or indirectly, i.e., for example, via a gear mechanism or, if appropriate, via a common electric control system, and can be regulated together, in order to convert a multi-zone air-conditioning system into an air-conditioning system having fewer zones. According to the prior art, a multiplicity of different inserts are known, with, as a rule starting from an air-conditioning system having fewer zones, the fitting of additional partitions resulting in the formation of a multi-zone air-conditioning system. In this case, control elements are provided in accordance with the number of zones desired. In contrast to this, starting from a multi-zone air-conditioning system, by simplifying the control system, preferably by providing flaps which can be coupled to one another directly or indirectly, an air-conditioning system having fewer zones is formed, with the number of zones customarily not being changed after installation. The coupling of the flaps preferably takes place from outside the air-guiding housing, so that the interior of the air-guiding housing, in particular the insert, is at least of essentially identical design in the different variants. Thus, a multi-zone base variant and a variant to this, which is of essentially identical design at least in the interior and has fewer zones, are produced.

The flaps are preferably fitted on the insert, so that simple preassembly is possible. The coupling of the flaps preferably takes place mechanically, in particular by means of a rigid connection of the two flaps, but a gear mechanism may also be provided.

The air-guiding housing for air-conditioning systems with a different number of zones is preferably of identical design at least in the region in which the insert is fitted. This makes it possible to increase the piece numbers, so that the production costs can be reduced.

At least one insert is preferably arranged in the air-guiding housing and, in one region of the same, has at least one partition, which separates two ducts, in particular two hot air ducts, which are assigned to different air-conditioning zones, from each other. The ducts can be assigned to the means of ventilating the interior and/or to the footwell.

A heater and/or additional heater are/is preferably arranged in an insert which, for its part, is arranged in the air-guiding housing. This makes it possible to design the ducts in accordance with requirements. Furthermore, the arrangement in the insert permits wider use of the air-guiding housing, since special refinements, for example for single- and two-zone and three- and four-zone air-conditioning systems, can be undertaken at the insert, such as, for example, the provision of coverings for ducts which are not required in the single- and two-zone application.

The insert is preferably designed in a corresponding manner for a single- and two-zone and/or a three- and four-zone air-conditioning system. In this case, there are generally structurally induced differences between the inserts for single- and two-zone air-conditioning systems and the inserts for three- and four-zone air-conditioning systems, so that—apart from a connection of the regulatable elements of the insert—the single- and the two-zone, and the three- and the four-zone air-conditioning systems are of identical construction.

The air-guiding housing is preferably of identical design for a single- and two-zone and/or a three- and four-zone air-conditioning system. In the event of differences between the construction of single- and two-zone air-conditioning systems and the construction of three- and four-zone air-conditioning systems, said differences can be eliminated by the use of different inserts, so that only one air-guiding housing is required and therefore an optimized modular construction of the air-conditioning system is possible.

The insert preferably also comprises an air-distributing device for distributing the air to the footwells. Said device may be injection molded onto the insert.

Alternatively, separately designed inserts for distributing the air to the footwells and inserts for controlling the air temperature may be provided. This is the case, in particular for production reasons, in four- and multi-zone air-conditioning systems.

The invention is explained in detail below using two exemplary embodiments with variants and with reference to the drawing, in which:

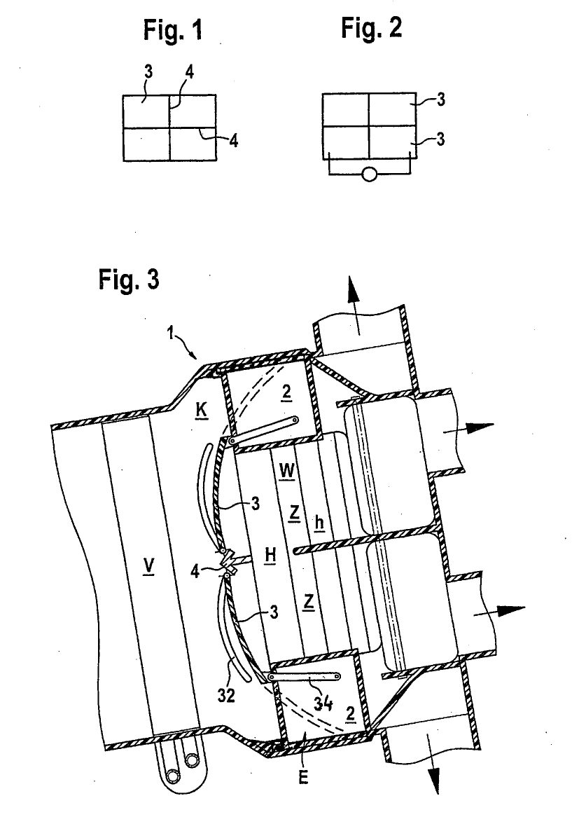

FIG. 1 shows a diagrammatic illustration of the centrally arranged hot air ducts of a four-zone automotive air-conditioning system according to the first exemplary embodiment (base version),

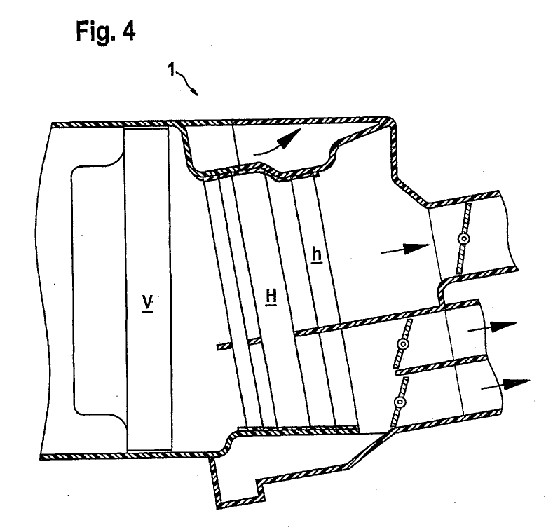

FIG. 2 shows a diagrammatic illustration, corresponding to FIG. 1, of the centrally arranged hot air ducts of the three-zone variant of the automotive air-conditioning system according to the first exemplary embodiment with the flap coupling illustrated diagrammatically,

FIG. 3 shows a section through a multi-zone air-conditioning system according to the first exemplary embodiment,

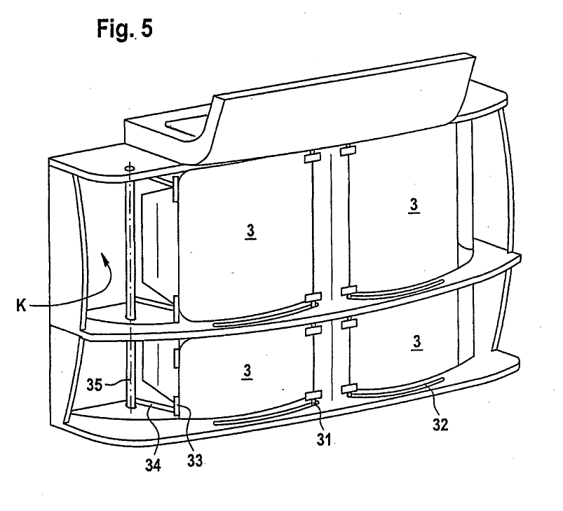

FIG. 4 shows a section perpendicular to the section illustrated in FIG. 3 through a multi-zone air-conditioning system according to the first exemplary embodiment,

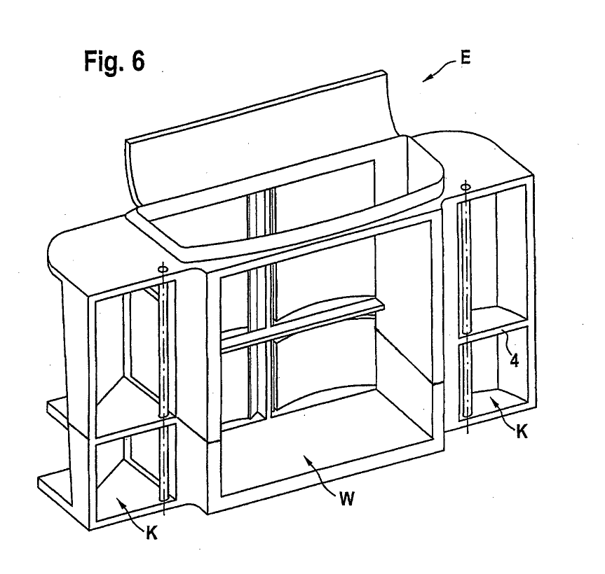

FIG. 5 shows a first perspective illustration of the insert according to the first exemplary embodiment,

FIG. 6 shows a second perspective illustration of the insert according to the first exemplary embodiment,

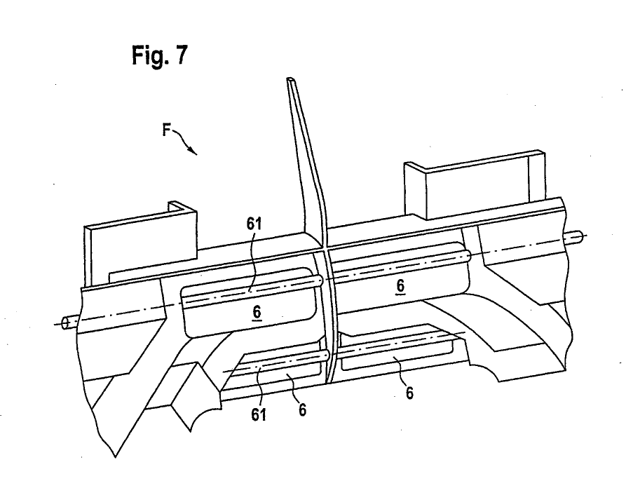

FIG. 7 shows a perspective view of an insert for the footwells according to the first exemplary embodiment,

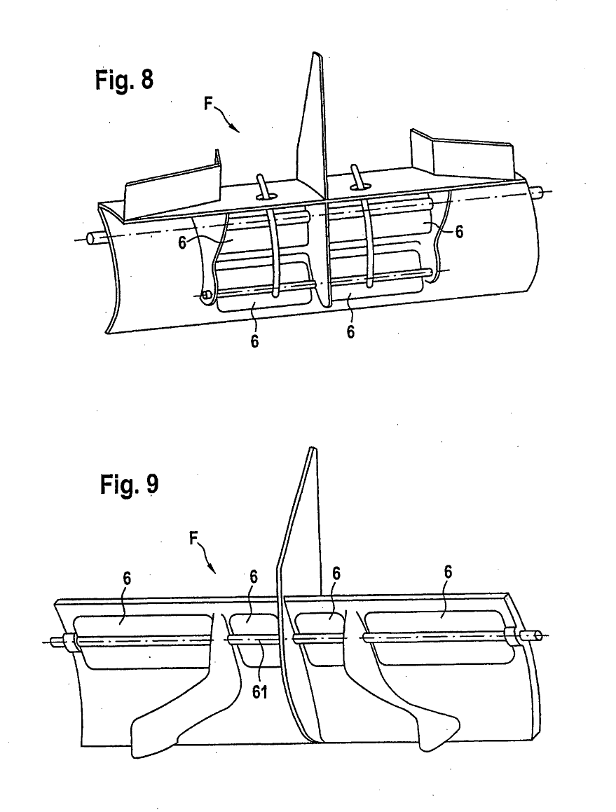

FIG. 8 shows a different perspective view of the insert from FIG. 7,

FIG. 9 shows a perspective view of an insert for the footwells according to a variant of the first exemplary embodiment,

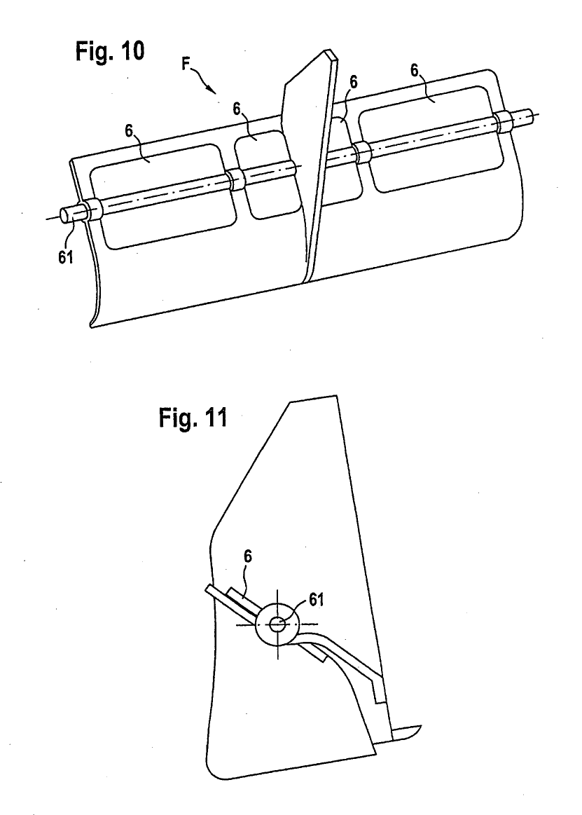

FIG. 10 shows a different perspective view of the insert from FIG. 9,

FIG. 11 shows a side view of the insert from FIG. 9,

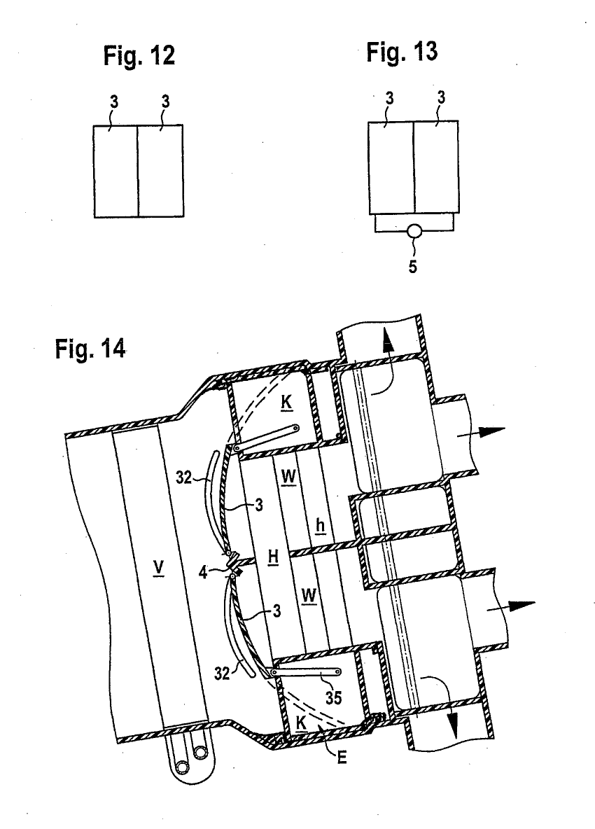

FIG. 12 shows a diagrammatic illustration of the centrally arranged hot air ducts of a two-zone automotive air-conditioning system according to the second exemplary embodiment (base version),

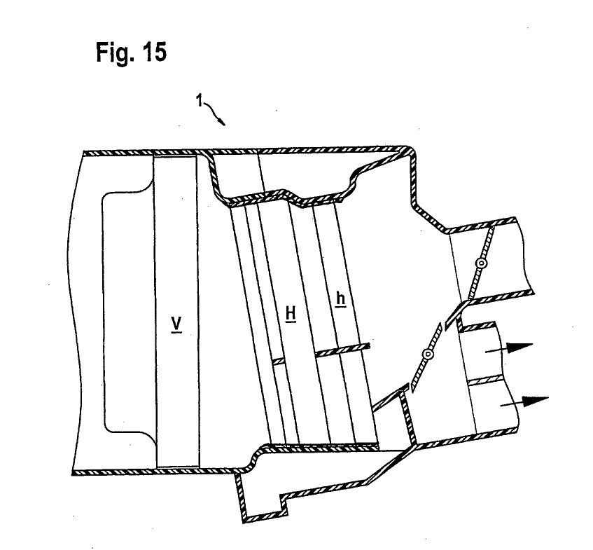

FIG. 13 shows a diagrammatic illustration, corresponding to FIG. 12, of the centrally arranged hot air ducts of the single-zone variant of the automotive air-conditioning system according to the second exemplary embodiment with the flap coupling illustrated diagrammatically,

FIG. 14 shows a section through a multi-zone air-conditioning system according to the second exemplary embodiment,

FIG. 15 shows a section perpendicular to the section illustrated in FIG. 14 through a multi-zone air-conditioning system according to the second exemplary embodiment,

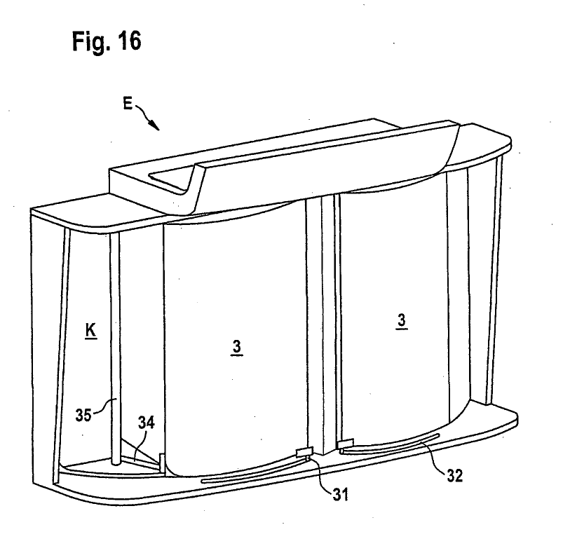

FIG. 16 shows a first perspective illustration of the insert according to the second exemplary embodiment,

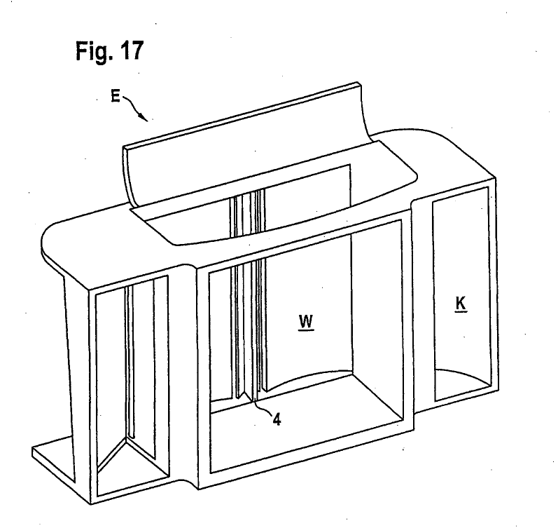

FIG. 17 shows a second perspective illustration of the insert from FIG. 16,

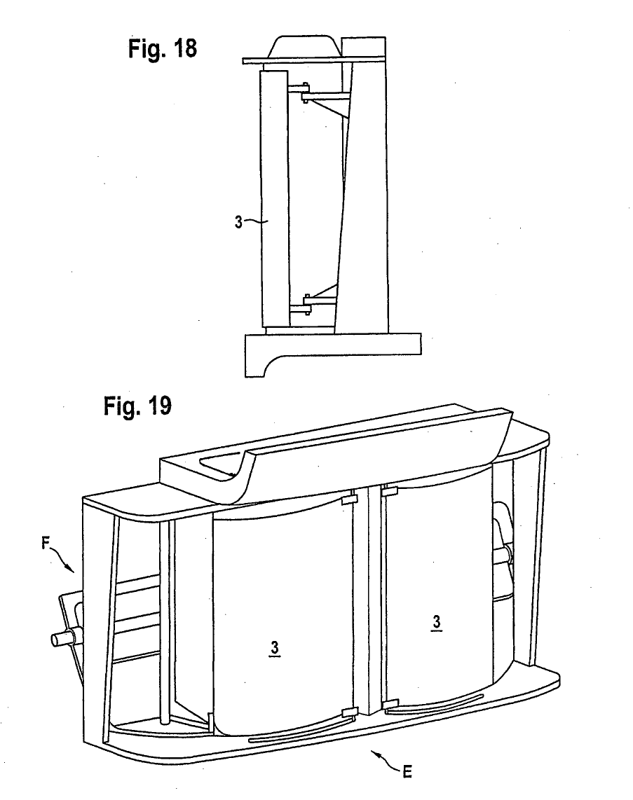

FIG. 18 shows a side view of the insert from FIG. 16,

FIG. 19 shows a perspective illustration of an insert with an insert for the footwells injection molded onto it, according to a variant of the second exemplary embodiment,

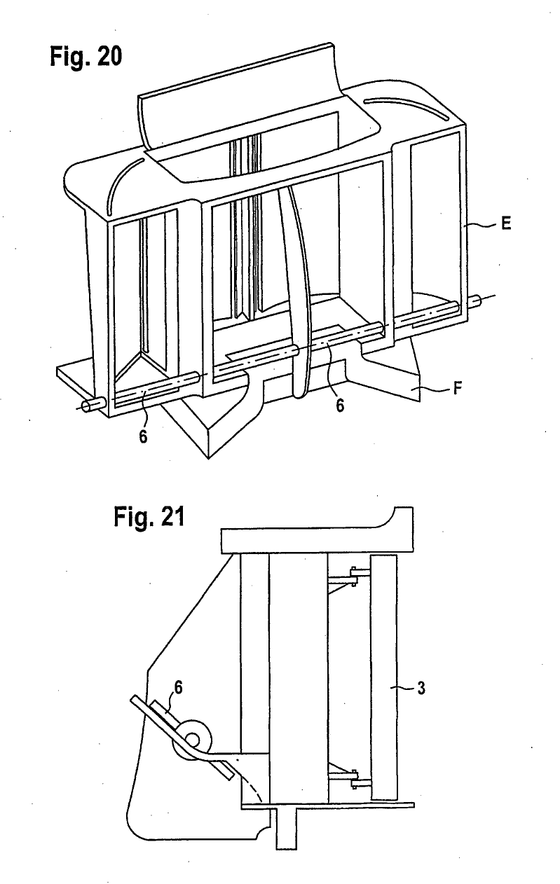

FIG. 20 shows a different perspective illustration of the insert from FIG. 19, and

FIG. 21 shows a side view of the insert from FIG. 19.

An automotive air-conditioning system has an air-guiding housing 1, as illustrated in FIG. 3, with a heater H, additional heater h and evaporator V arranged in the same, wherein the air-guiding housing 1, for manufacturing and assembly reasons, is of multi-part design in the form of a plastic injection molded component. Air to be conditioned is conveyed via a fan (not illustrated) through the air-conditioning system and, if appropriate, is conducted via an air filter. A plurality of air ducts 2 and flaps 3 for controlling the air flow with the aid of inserts E are formed or arranged in the air-guiding housing 1.

According to the first exemplary embodiment, which is illustrated in FIGS. 1 and 2 and has a variant, the base version provided is a four-zone air-conditioning system which has centrally arranged hot air ducts W, which are assigned in each case to the four air-conditioning zones and are separated from one another by two intersecting partitions 4, which are part of the insert E, and cold air ducts K (not illustrated in FIGS. 1 and 2) arranged at the sides of said hot air ducts. To regulate the air temperature, each of the air-conditioning zones is assigned a flap 3 which can be activated directly via a control device, is driven by a servomotor, and which can be moved independently of the other flaps 3.

The flaps 3 are fitted pivotably and displaceably on the insert E. On one side, they have pins 31 which are guided in slots 32 (see FIG. 5), and are mounted on their other side with a hinge 33 which is arranged at an end of an arm 34 which extends from a shaft 35 (see FIG. 6), so that the flaps 3 can carry out the required pivoting and displacement movement. The arrangement of the flaps 3 is mirror-inverted with respect to the central plane, which runs parallel to the shafts 35.

In the present case, the flaps 3 assigned to the front region of the motor vehicle are designed to be twice as high as the flaps 3 assigned to the region below said flaps and to the rear region, but mutually corresponding flap sizes are also possible. The flaps 3 are connected to a respective servomotor via the shafts 35, which protrude beyond the air-guiding housing 1. In this case, switchable gear mechanisms may also be provided, so that one servomotor can actuate different flaps 3 independently of one another.

The insert E is arranged in the air-guiding housing 1 and is inserted into the same during installation. In this case, the insert E is held in the air-guiding housing 1 in such a manner that the flow profile of the air is negatively influenced to the least possible degree, for which purpose the air-guiding housing 1 is correspondingly expanded, so that, as far as possible, no edges protrude into the air flow path in the region of the transitions. In addition, the insert E holds the heater H and the additional heater h (cf. FIG. 3). It is of multi-part design for manufacturing reasons, as can be gathered, in particular from FIG. 6, with, according to the present exemplary embodiment, a division being provided in the horizontal direction level with the horizontally running partition 4, and the two parts being connected to each other by means of clip connections, so that the heater H and the additional heater h are positioned in the insert E during installation. For optimum positioning of heater H and additional heater h, the insert E in each case has an introductory shaft (cf. FIG. 6) correspondingly formed with the aid of ribs running in the introductory direction, and, if appropriate, further positioning elements, such as, for example, further ribs serving as a stop, so that, upon introduction, said elements are automatically positioned correctly in the insert E and are held in a manner secure against wobbling.

In order, during manufacturing, to make a three-zone air-conditioning system with a simplified control system from a four-zone air-conditioning system, a mechanical flap coupling 5, which is illustrated diagrammatically in FIG. 2, is provided and connects the flaps 3 assigned to zones 3 and 4, so that they can be controlled via a common control device. Instead of four control devices, only three control devices are therefore required. In this case, the two flaps 3 present, which are assigned to the rear region, are coupled. According to the present variant of the first exemplary embodiment, the coupling takes place outside the air-guiding housing 1, so that, in the base variant (exemplary embodiment 1) and the variant to this, at least the interior of the insert E is of identical design. Differences between base variant and variant only arise outside the air-guiding housing 1 on account of the connection provided here to the servomotors, with, in the case of the base variant, four servomotors being provided and, in the case of the variant, only three servomotors being provided, since, in the case of the variant, two flaps 3 are coupled with the aid of a gear mechanism (not illustrated) arranged outside the air-guiding housing, so that the coupled flaps 3 can be actuated synchronously.

In principle, a two- or even single-zone air-conditioning system with a correspondingly simplified control system can be made from the four-zone air-conditioning system by means of appropriate couplings, so that very large piece numbers are possible at least for parts of the air-guiding housing and the insert, as a result of which the production costs can be reduced. For example, the front region and the rear region or the right side and the left side can be coupled in each case to one another.

Owing to basic differences, which are generally present, in the air guidance, such as that, in the case of single- and two-zone air-conditioning systems, no B-pillar outlet is usually provided, there are generally modules, in particular also with regard to the air-guiding housing, for single- and two-zone air-conditioning systems, and modules which are configured differently therefrom, for three- and four-zone air-conditioning systems, with in each case the two- and four-zone air-conditioning system forming the base variant. The single- and three-zone air-conditioning systems are formed therefrom as variants by coupling of the flaps and, if appropriate, other slight structural changes, such as, for example, closing of openings, for example a B-pillar outlet of the air-guiding housing.

For the footwells of the individual zones, according to the first exemplary embodiment a further insert F with flaps 6 integrated therein is provided in the air-guiding housing 1, with it being possible again for the individual flaps 6 to be separated in the case of a four-zone air-conditioning system and for them to be coupled in the case of a three-zone air-conditioning system. The insert F forms an air-distributing device to the footwells and in the present case, for manufacturing reasons, is formed separately from the insert E.

The insert F, which is illustrated in FIGS. 7 and 8, has four flaps 6 which are arranged in two rows each having two flaps 6. The flaps 6 of each row pivot about the same pivot axis 61. Control can take place—depending on the intended purpose—independently of one another, in a partially coupled manner or coupled to one another. The actuation takes place in a manner known per se.

FIGS. 9 to 11 illustrate a variant of the insert F with four flaps 6 arranged next to one another, with all of the flaps 6 being pivotable about the same pivot axis 61. The control can take place as per FIGS. 7 and 8. For independent control of the flap 6, one flap 6 can have a hollow shaft through which the shaft of another flap 6 is guided.

According to a further variant, just one continuous flap for all of the footwells is provided in the insert, so that no zone-dependent control of the temperature and ventilation of the footwell takes place.

The second exemplary embodiment, which is illustrated in FIGS. 12 to 21 and has variants, corresponds in principle to the first exemplary embodiment and variant, but the base variant provided is a two-zone automotive air-conditioning system which has two hot air ducts W separated from each other by a partition 4 and two cold air ducts K arranged at the sides of said hot air ducts. In the case of the base variant, in order to regulate the air temperature, each of the two air-conditioning zones is assigned a flap 3 which can be activated directly via a control device arranged outside the air-guiding housing 1 and which can be moved independently of the other flap 3.

In the case of the single-zone variant, in a comparable manner to the variant of the first exemplary embodiment, a coupling of the two flaps 3 by means of a mechanical flap coupling 5 takes place outside the air-guiding housing 1, so that only one control device is required.

According to the variant illustrated in FIGS. 16 to 18, as in the first exemplary embodiment, a second insert is provided, which forms the air-distributing device for the footwells of the individual zones. In this connection, an insert with two flaps can be used in the case of a two-zone air-conditioning system and, in the case of a single-zone air-conditioning system, a different insert with a large flap can be used, but a coupling of the two flaps of the two-zone insert is also possible. In principle, in the case of a two-zone air-conditioning system, a single-zone configuration of the footwell ventilation can also be provided, so that a continuous flap can be used in this case.

According to the variant illustrated in FIGS. 19 to 21, the insert F is injection molded on and is therefore formed integrally with the insert E, thus somewhat simplifying the installation. The insert F has two flaps 6 which can be controlled independently of each other and are coupled to each other in the case of a single-zone air-conditioning system.

For manufacturing reasons, the insert F can only be injection molded on to a limited extent in the case of the three- or four-zone configuration, so that, in this case, the multi-part configuration is preferred.

1. An air-conditioning system, especially automotive air-conditioning system, with an air-guiding housing and components arranged in the same, such as at least one heater and an insert, for guiding and/or mixing the air, wherein the insert and/or the air-guiding housing have/has elements which can be connected to one another directly or indirectly and can be regulated together, in order to convert a multi-zone air-conditioning system into an air-conditioning system having fewer zones.

2. The air-conditioning system as claimed in claim 1, wherein the elements which can be connected to one another directly or indirectly and can be regulated together are formed by flaps.

3. The air-conditioning system as claimed in claim 2, wherein at least two flaps of an air-conditioning system having fewer zones are coupled permanently to one another and, in the multi-zone variant, can be controlled independently of one another.

4. The air-conditioning system as claimed in claim 2, wherein the flaps are fitted on the insert.

5. The air-conditioning system as claimed in claim 2, wherein the coupling of the flaps takes place mechanically.

6. The air-conditioning system as claimed in claim 2, wherein the coupling of the flaps is provided essentially outside the insert.

7. The air-conditioning system as claimed in claim 2, wherein the coupling of the flaps is provided essentially outside the air-guiding housing.

8. The air-conditioning system as claimed in claim 1, wherein air-guiding housings for air-conditioning systems with a different number of zones are of identical design at least in the region in which the insert is fitted.

9. The air-conditioning system as claimed in claim 1, wherein at least one insert is arranged in the air-guiding housing and, in one region of the same, has at least one partition which separates two ducts, which are assigned to different air-conditioning zones, from each other.

10. The air-conditioning system as claimed in claim 1, wherein a heater and/or additional heater are/is arranged in an insert which is arranged in an air-guiding housing.

11. The air-conditioning system as claimed in claim 1, wherein the insert is of identical design for a single- and two-zone and/or a three- and four-zone air-conditioning system.

12. The air-conditioning system as claimed in claim 1, wherein the air-guiding housing is of identical design for a single- and two-zone and/or a three- and four-zone air-conditioning system.

13. The air-conditioning system as claimed in claim 1, wherein the insert comprises an air-distributing device for distributing the air to the footwells.

14. The air-conditioning system as claimed in claim 1, wherein an insert for distributing the air to the footwells is formed separately from an insert (E) for controlling the air temperature.

15. The air-conditioning system as claimed in claim 1, wherein the insert has a mirror-inverted construction, with hot air ducts being formed at least in some regions centrally and cold air ducts being formed at the sides.

16. The air-conditioning system as claimed in claim 1, wherein the air-conditioning system comprises at least an evaporator, a filter or a fan.
